(19) United States
(12) Patent Application Publication
(10) Pub. No.: US 2010/0107097 A1
(43) Pub. Date: Apr. 29, 2010

(54) Client device with extensible imaging device driver and method implementing same

(76) Inventor: Andrew Rodney Ferlitsch, Camas, WA (US)

Correspondence Address: SHARP LABORATORIES OF AMERICA, INC., 1320 PEARL ST., SUITE 228, BOULDER, CO, 80302, US

(21) Appl. No.: 12/288,106

(22) Filed: Oct. 16, 2008

(51) Int. Cl. G06F 7/06; G06F 17/30; G06F 3/048

(52) U.S. Cl. 715/764; 707/E17.014

(57) ABSTRACT

A client device has an imaging device driver that is automatically extensible to meet diverse imaging requirements. When an imaging job is initiated, the extensible device driver queries the target imaging device and identifies a feature set. The device driver then identifies features within the feature set that are locally supported. The device driver then queries one or more remote server devices and identifies one or more plugins that will enable the device driver to support features within the feature set that are not locally supported. The device driver then obtains authorization from the user (e.g. agreement to terms of license) and downloads and stores the plugins. The device driver may also query one or more remote servers and identify, download and store updates to the device driver's core and to previously downloaded and stored plugins. A method for using the extensible device driver is also disclosed.

### BACKGROUND OF THE INVENTION

The present invention relates to a client device having an imaging device driver and a method implementing such a device driver and, more particularly, to a client device having an imaging device driver that is automatically extensible to meet diverse imaging requirements and a method implementing such a device driver.

Conventionally, each imaging device (e.g. printing device) model sold by a manufacturer has been optimized for use with its own model-specific device driver. Attempted use of a device driver optimized for a different imaging device model to operate an imaging device would typically fail entirely, produce an unexpected result or operate only a limited set of features of the imaging device.

Model-specific imaging device drivers have presented several problems in conventional computing environments. First, where different imaging device models are operative in such an environment there has been a need to independently administer (e.g. install, upgrade, replace) multiple device drivers. Second, mobile client devices operating in such an environment on a temporary basis have not known what device drivers are required and how to acquire them. Third, client devices operating in such an environment have had difficulty accessing on-demand features, such as workflow integration features.

Recently, more flexible imaging device drivers that address some of these issues have been marketed. For example, Hewlett-Packard Corp. and Xerox Corp. have offered Universal Printer Drivers (UPD) that support preconfigured “personalities” for a number of printing devices. When such a UPD is invoked, the UPD queries the target printing device for model and configuration information, identifies a personality that matches the model and configuration and automatically adapts to support a feature set based on the identified personality. However, such a UPD cannot automatically adapt to a feature set if the model and configuration does not correspond to one of the preconfigured personalities. Moreover, since the personalities are preconfigured, the UPD cannot automatically adapt to include updates to a personality released after the configuration and cannot automatically adapt to support on-demand features, such as workflow integration features. Additionally, such a UPD does not support any mechanism for licensing features on a temporary basis, such as a subscription or pay-per-use basis.

### SUMMARY OF THE INVENTION

The present invention, in a basic feature, provides a client device having an imaging device driver that is automatically extensible to meet diverse imaging requirements and a method implementing such a device driver. When an imaging job is initiated, the extensible device driver queries the target imaging device and identifies a feature set. The device driver then identifies features within the feature set that are locally supported. The device driver then queries one or more remote server devices and identifies one or more plugins that will enable the device driver to support features within the feature set that are not locally supported. The device driver then obtains authorization from the user (e.g. agreement to terms of license) and downloads and stores the plugins. The device driver may also query one or more remote servers and identify, download and store updates to the device driver's core and to previously downloaded and stored plugins.

In one aspect of the invention, a method for automatically adapting an extensible imaging device driver comprises the steps of querying a target imaging device, identifying based on a query response received from the target imaging device a feature set, identifying one or more features within the feature set that are locally supported using the device driver, querying one or more remote server devices, identifying based on one or more query responses received from the remote server devices one or more plugins that will enable the device driver to locally support additional features within the feature set, downloading the plugins and locally storing the plugins.

In some embodiments, the feature set is a full feature set for the target imaging device. In some embodiments, the feature set is a partial feature set for the target imaging device that addresses host emulation. In some embodiments, the feature set is a partial feature set for the target imaging device that addresses a workflow integration.

In some embodiments, the step of identifying one or more features within the feature set that are locally supported using the device driver comprises identifying one or more features that are natively supported by a device driver core and one or more features that are supported using plugins invoked by the device driver core.

In some embodiments, the remote server devices are queried via the Internet. In some embodiments, the remote server devices are queried via a cellular network.

In some embodiments, the method further comprises the steps of identifying based on one or more query responses received from the remote server devices one or more update plugins that will update the device driver core, downloading the update plugins and storing the update plugins.

In some embodiments, the method further comprises the steps of identifying based on one or more query responses received from the remote server devices one or more update plugins that will update plugins invoked by the device driver core, downloading the update plugins and storing the update plugins.

In some embodiments, the method further comprises the step of displaying information about the plugins to a user and obtaining authorization from the user to download the plugins. In some embodiments, the displayed information includes licensing terms. In some embodiments, the displayed information includes information indicating an extent to which the plugins will enable the device driver to locally support features within the feature set.

In some embodiments, the stored plugins and the device driver are collocated on a client device.

In some embodiments, the plugins are operative for a predetermined term. In some embodiments, the plugins are operative for a predetermined number of uses.

In some embodiments, the plugins comprise a user interface description.

In another aspect of the invention, a client device comprises a processor and a communication interface communicatively coupled with the processor, wherein under control of the processor the client device queries a target imaging device via the communication interface, identifies based on a query response received from the target imaging device via the communication interface a feature set, identifies one or more features within the feature set that are locally supported, queries one or more remote server devices via the communication interface, identifies based on one or more query responses received from the remote server devices via the communication interface one or more plugins that will enable an extensible device driver on the client device to locally support additional features within the feature set and downloads and stores the plugins.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a communication system in which the present invention is operative in some embodiments.

FIG. 2 shows a client device in which the present invention is operative in some embodiments.

FIG. 3 shows software elements with which the present invention is operative in some embodiments.

FIG. 4 shows a method for automatically adapting an extensible imaging device driver to include plugins in some embodiments of the invention.

FIG. 5 shows a method for selecting an imaging control user interface description for rendering in some embodiments of the invention.

FIG. 6 shows a method for automatically adapting an extensible imaging device driver to include update plugins in some embodiments of the invention.

### DETAILED DESCRIPTION OF A PREFERRED EMBODIMENT

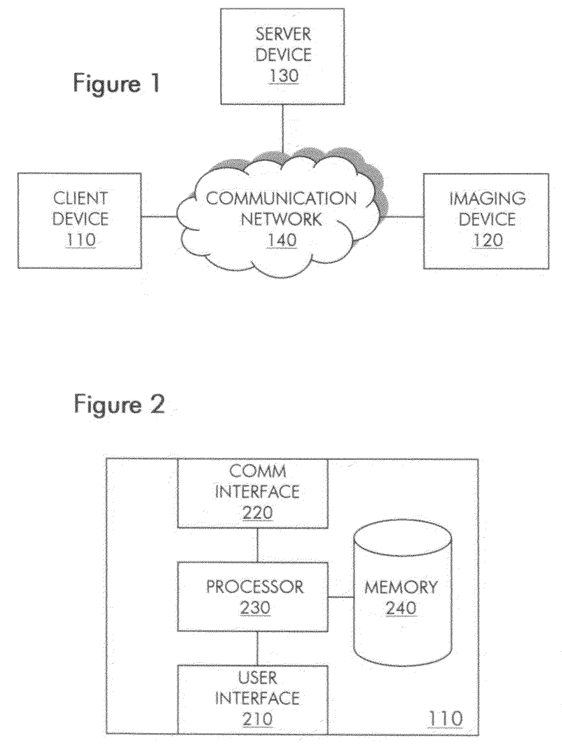

FIG. 1 shows a communication system in which the present invention is operative in some embodiments. The communication system includes a client device 110 communicatively coupled with an imaging device 120 and a server device 130 via a communication network 140.

Client device 110 is a network-capable computing device that has software executable by a processor to perform various tasks including discovering a feature set from imaging device 120, automatically adapting an extensible imaging device driver to support the discovered feature set and preparing and managing imaging jobs. By way of example, client device 110 may be a desktop personal computer (PC), mobile PC, personal data assistant (PDA), mainframe computer, minicomputer, mobile phone, digital television set or Internet appliance.

Imaging device 120 may be a single-function imaging device or multifunction peripheral device (MFP). Imaging device 120 has software executable by a processor to respond to discovery requests and manage imaging jobs in conformance with a supported feature set and an electromechanical section to execute imaging jobs. Imaging functions supported by imaging device 120 may include, by way of example, printing, copying, scanning, filing, faxing, media duplication, publishing, displaying, format translation, editing and audio/visual record/playback. In the case of the printing function, a supported feature set may include, by way of example, one or more printer languages, host emulation features, accounting features, licensing features, payment features, special features and/or workflow integration features.

Server device 140 is a web server remote from client device 110 that manages extensible imaging device driver plugins. Server device 140 responds to queries made by client device 110 for information about available plugins and downloads plugins to client device 110 where appropriate. Server device 130 may be operated by the manufacturer of imaging device 120, owner of client device 110 or a third party.

Communication network 130 includes data networking devices and links that interconnect client device 110, imaging device 120 and server device 130. The links may be wired, wireless or some combination thereof. By way of example, communication network 130 may have one or more Institute of Electrical and Electronics Engineers (IEEE) 802.3 (wired Ethernet), IEEE 802.11 (wireless LAN), IEEE 802.16 (WiMax), wide area, cellular and/or ad-hoc networking devices and links for interconnecting client device 110 and server device 130 via the Internet or a cellular network. Communication network 130 may have a similar collection of networking devices and links, or a dedicated link, such as an RS-232 (COM), Universal Serial Bus (USB), IEEE Std. 1284 (Parallel Port), IEEE Std. 1394 (FireWire), Bluetooth, Near Field Communication (NFC), Infrared Data Association (IrDa) link, for interconnecting client device 110 and imaging device 120.

While in the illustrated embodiment there is shown to be one client device 110, one imaging device 120 and one server device 130, it will be appreciated that in other embodiments there may be a multiple of one or more of these device types. For example, in some embodiments there may be a multiple of server devices, each one supporting extensible imaging device driver plugins for imaging devices made by a different imaging device manufacturer.

FIG. 2 shows client device 110 in more detail to include a user interface 210, a communication interface 220 and a memory 240, all of which are communicatively coupled with a processor 230. User interface 210 has an input mechanism, such as a keyboard, keypad, touch screen and/or voice command module for accepting inputs from a human user and an output mechanism, such as a liquid crystal display (LCD), light emitting diode (LED) display, cathode ray tube (CRT) and/or loudspeaker for displaying outputs to a user. Communication interface 220 has one or more data communication ports for communicatively coupling client device 110 with imaging device 120 and server device 130 via communication network 140. As one of numerous examples, communication interface 220 may include a wireless LAN port over which client device 110 establishes Internet connectivity and communicates with server device 130 and a USB port over which client device 110 communicates directly with imaging device 120. Memory 240 includes one or more random access memories (RAM) and one or more read only memories (ROM). Processor 230 executes software installed in memory 240 to carry-out operations on client device 110 including discovering a feature set for imaging device 120, automatically adapting an extensible imaging device driver to support the discovered feature set and preparing and managing imaging jobs.

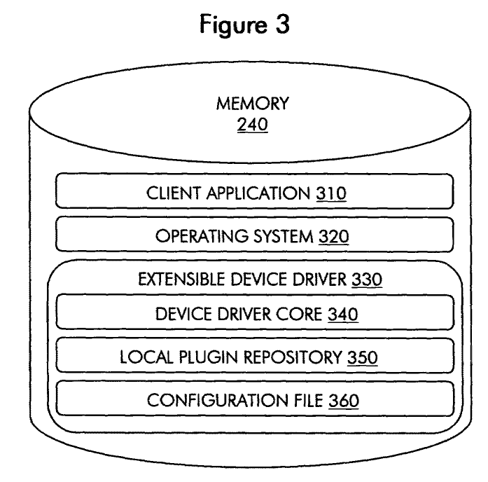

FIG. 3 shows software elements stored in memory 240 to include a client application 310, an operating system 320 and an extensible imaging device driver 330. Extensible imaging device driver 330 has a device driver core 340, a local plugin repository 350 and a configuration file 360. Client application 310 allows a user, via user interface 210, to create, edit, save, open and view digital documents and initiate imaging jobs respecting digital documents. When the user initiates an imaging job and selects a target imaging device, client application 310 converts the application-formatted digital document into device-independent graphical primitives understood by operating system 320. Operating system 320 sends the graphical primitives to extensible imaging device driver 330. Extensible imaging device driver 330 converts the graphical primitives into an imaging format supported by the target imaging device for the imaging job. Such conversion may be performed natively by device driver core 340 if device driver core 340 natively supports an imaging format supported by the target imaging device. If device driver core 340 does not natively support an imaging format supported by the target imaging device, device driver core 340 may invoke an appropriate plugin in local plugin repository 350 to facilitate the conversion.

Taking a specific example, where client application 310 is Microsoft Word and a user wishes to print a Word document on imaging device 120, client application 310 converts the Word document into device-independent graphical primitives [e.g. Graphical Display Interface (GDI), XML Paper Specification (XPS) primitives] understood by operating system 320, which sends the primitives to extensible imaging device driver 330. Extensible imaging device driver 330 converts the primitives into a printer language supported by imaging device 120 [e.g. Printer Control Language (PCL), Postscript, Tagged Image File Format (TIFF), Portable Document Format (PDF)]. If the printer language is natively supported by device driver core 340, conversion of the primitives into a printer language may be accomplished by device driver core 340 without resort to local plugin repository 350. If, however, the printer language is not natively supported by device driver core 340, device driver core 340 invokes a plugin from repository 350 to assist with the conversion.

Extensible imaging device driver 330 performs other processing to prepare an imaging job for submission to imaging device 120. By way of example, additional processing may include host emulation processing, accounting processing, licensing processing, payment processing, special feature processing and/or workflow integration processing. To the extent additional processing is natively supported by device driver core 340, device driver core 340 may perform such additional processing without resort to local plugin repository 350. To the extent additional processing is not natively supported by device driver core 340, however, device driver core 340 invokes plugins in local plugin repository 350 to assist with the processing.

Local plugin repository 350 has various plugin types stored therein for assisting device driver core 340, such as printer language plugins (e.g. PCL, Postscript, TIFF, PDF, raster format plugins), host emulation plugins [e.g. N-up, Booklet, Z-fold, raster image processing (RIP), half-toning, color space conversion, image enhancement plugins]; accounting, licensing and payment plugins (e.g. public printing, departmental printing, content royalties, special paper fee plugins); command plugins (e.g., command codes specific to the target imaging device); and/or special feature/workflow integration plugins (e.g. document indexing/filing, broadcast print, Bates stamping, barcodes, overlays, auditing, redaction, document composition plugins). Plugins may be integrated on a temporary basis with device driver core 340 using various means, such as dynamic linking of a Dynamic Linked Library (DLL), execution using Inter-Process Communication (IPC) (e.g. COM executable), command pipelining, open application programming interface (API) calls or Web Service calls.

While local plugin repository 350 is shown in memory 240 on client device 110, in some embodiments all or part of the local plugin repository may be disposed on an external storage device, such as an external hard drive or USB thumb drive, that is locally accessible to client device 110.

Local plugin repository 350 may also include plugins that update or otherwise enhance a feature that is natively supported by device driver core 340. When local plugin repository 350 has such an update plugin that is operative, configuration file 360 is modified to indicate to use the update plugin in place of a DLL for the natively supported feature. That way, when configuration file 360 is read upon startup, device driver core 340 will load the update plugin instead of the DLL.

Once imaging job preparation has been completed, with or without assistance of plugins, extensible imaging device driver 330 under control of processor 230 sends the imaging job to imaging device 120 via communication interface 220, whereupon imaging device 120 services the imaging job (e.g. outputs a “hard copy” of a digital document).

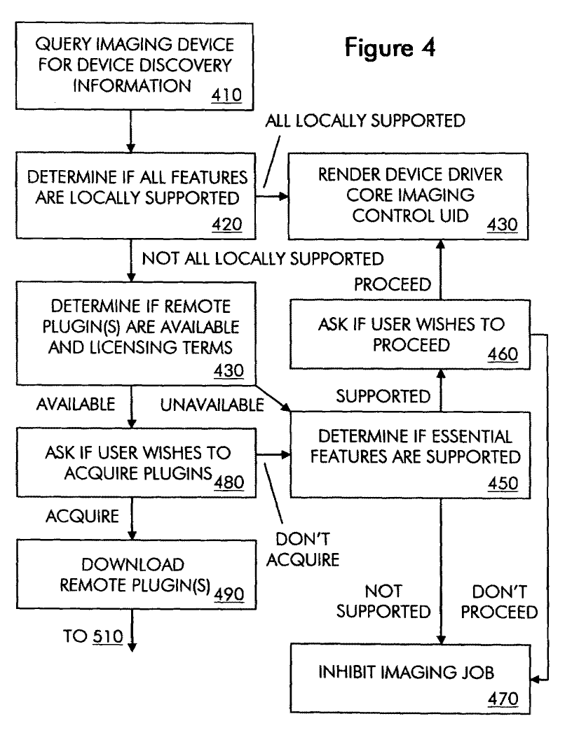

As part of imaging job processing, client device 110 discovers a feature set from imaging device 120 and automatically adapts itself to support the discovered feature set. FIG. 4 shows a method for performing discovery and automatically adapting extensible imaging device driver 330 with plugins in some embodiments of the invention. When a user of client device 110 initiates via user interface 210 an imaging job and identifies imaging device 120 as the target device, device driver core 340 queries imaging device 120 for device discovery information (410). In some embodiments, device driver core 340, under control of processor 230, generates and transmits via communication interface 220 a discovery request soliciting manufacturer, model, configuration, capabilities and/or other device discovery information for imaging device 120 from which a comprehensive feature set for imaging device 120 can be identified. In other embodiments, the discovery request solicits device discovery information for a workflow integration or special feature, such as a host emulation feature, from which a partial feature set for imaging device 120 can be identified. As one example, an integrated workflow may convert a digital document to raster data, insert a predetermined watermark and a timestamp and file the modified raster data into a predetermined filing storage element. In response to a discovery request, device driver core 340 receives from imaging device 120 a discovery response including requested device discovery information. Various protocols may be used to carry the discovery request and response, such as Simple Network Management Protocol (SNMP), Web Services (WDPrint) or Printer Job Language (PJL).

Device driver core 340 determines based on the discovery response whether all features of the feature set are locally supported (420). In some embodiments, device driver core 340 resolves device discovery information in the discovery response to a feature set and compares the feature set with features locally supported by extensible device driver 330, either natively by device driver core 340 or with the assistance of one or more plugins stored in local plugin repository 350. If all features are locally supported, remote searching for additional plugins is not required and the imaging control user interface description (UID) native to device driver core 340 is rendered on user interface 210. The user may then select on user interface 210 imaging settings and submit the imaging job to imaging device 120 (430). If, however, all features are not locally supported, device driver core 340 determines whether remote plugins are available that can remedy deficiencies in local support (440). In some embodiments, device driver core 340 queries server device 130 via the Internet for web hosted plugins that can remedy deficiencies in local support and licensing terms for such plugins, in response to which server device 130 issues a query response. Naturally, device driver core 340 may query more than one server device if necessary. Plugin queries and responses may be carried over various protocols, such as HyperText Transfer Protocol/HyperText Markup Language (HTTP/HTML), SOAP over extensible Markup Language (SOAP/XML) or a proprietary protocol over Transport Control Protocol/Internet Protocol (TCP/IP). Alternatively, a transfer protocol, such as File Transfer Protocol (FTP) or Direct Internet Message Encapsulation (DIME), may be used. Plugins and their associated licensing terms may be stored and retrieved on server device 130 using various search parameters, such as the manufacturer or model identifier of imaging device 120, a feature identifier, and/or job ticket [e.g. PJL, XML Paper Specification (XPS) Print Ticket, WS Print Ticket], and using various search techniques, such as meta-tagging of plugins using keywords encoded in filenames, supplemental data added to a file, header or shadow file, and/or database search. Licensing terms for plugins may include a fee component and a usage component. The fee component may specify the cost to the user, if any, and the usage component may specify usage restrictions, if any. The fee component may specify, for example, a one-time, a periodic or per-use fee, and the usage component may specify, for example, a perpetual term, a definite term, or a predetermined number of uses.

If no remote plugins are available to remedy deficiencies in local support, device driver core 340 determines whether essential features that would enable imaging to proceed under a reduced feature set are locally supported (450). If essential features are not locally supported, the imaging job is inhibited (470). If essential features are locally supported, the user is queried via user interface 210 as to whether he or she wishes to proceed with imaging under the limited feature set (460). If the user indicates by user input that he or she does not wish to proceed, the imaging job is inhibited (470). If the user indicates through user input that he or she wishes to proceed, the imaging control UID native to device driver core 340 is rendered on user interface 210 and the user may select imaging settings and submit the imaging job (430).

If remote plugins are available to remedy deficiencies in local support, device driver core 340 queries the user via user interface 210 as to whether he or she wishes to acquire the plugins (480). In some embodiments, the user is presented on user interface 210 with a list of the plugins and license terms, as well as an indication of whether full support for the feature set will be realized if the plugins are acquired, and is asked to indicate through user input a decision as to whether to acquire the plugins. If the user through user input declines to acquire the plugins, the flow returns to Step 425. If the user by user input expresses a desire to acquire the plugins, driver core 340 downloads the plugins and stores them in local plugin repository 350 (490), whereupon access rights to the plugins are granted as per the agreed licensing terms and the flow proceeds to Step 510. In some embodiments, payment for plugins is requested and made through a one-time credit or debit card transaction at the time of acquisition. In other embodiments, payment is made by one-time debit of a prepaid account. In still other embodiments, payment is made through credit or debit card transactions or prepaid account deductions on a recurring billing cycle. In still other embodiments, payment is made by credit or debit card transactions or prepaid account deductions on a per-use basis. When the term of license for a plugin has expired or the licensed number of uses has been exhausted, the plugin may be deleted from local plugin repository 350 or persist in a disabled state, such as an encrypted state wherein there is no functioning license key.

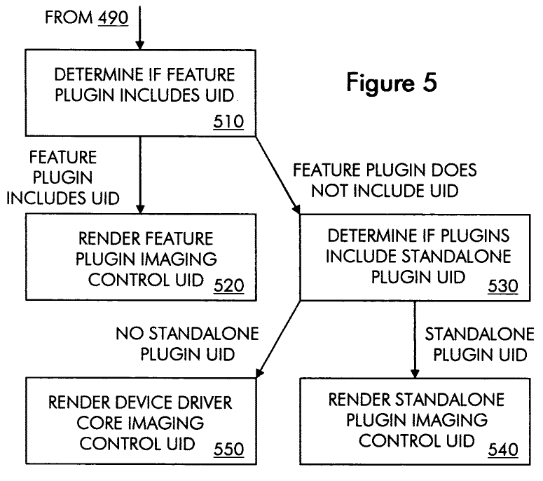

FIG. 5 shows a method for selecting an imaging control UID for rendering on user interface 210 in some embodiments of the invention. The UID includes a menu from which a user can select imaging settings for application to an imaging job. In some embodiments, the UID is an eXtensible Markup Language (XML) file that has various information for each imaging setting, such as a title, a data type (e.g. integer, enumerated type), a data range (e.g. A4, A5, A6, letter, legal paper size) and a grouping indication (e.g. display alongside imaging setting X). After remote plugins are downloaded in Step 490, a first check is made to determine whether any of the downloaded plugins that remedies a feature deficiency has an integral imaging control UID (510). If so, the integral UID is rendered on user interface 210 (520). If not, a second check is made to determine whether any of the downloaded plugins is a standalone imaging control UID (530). A standalone imaging control UID may, for example, provide a site-specific (e.g. corporate) look and feel to user interface 210. If so, the standalone UID is rendered on user interface 210 (540). If not, the imaging control UID native to device driver core 340 is rendered on user interface 210 (550).

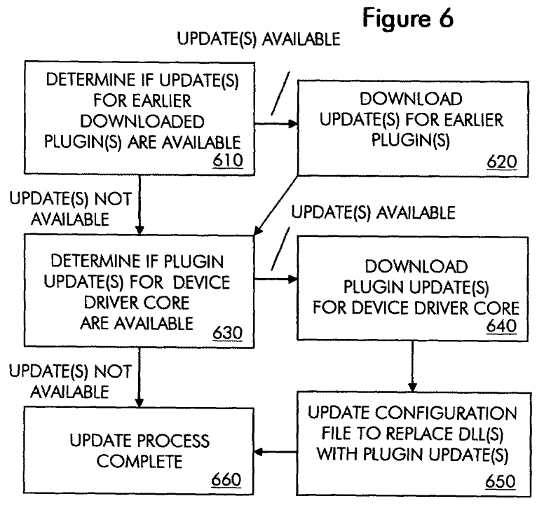

FIG. 6 shows a method for performing discovery and automatically adapting extensible imaging device driver 330 with update plugins in some embodiments of the invention. In addition to downloading plugins that remedy deficiencies in local support, device driver core 340 may search server device 130 and download remote plugins that update or otherwise enhance device driver core 340 and/or plugins previously downloaded and stored in local plugin repository 350. Searches for such update plugins may be performed episodically, such as upon detection of new features or firmware on imaging device 120 or manual initiation by a user of client device 110, or may be performed periodically. In some embodiments, device driver core 340 queries imaging device 120 for its firmware level as part of feature set discovery and stores the firmware level in memory 240. Then, whenever a change in the firmware level is detected device driver core 340 initiates a search on server device 130 for an update plugin corresponding to the current firmware level. In the exemplary flow shown in FIG. 6, device driver core 340 determines whether one or more update plugins for earlier downloaded plugins are available (610). If one or more update plugins for earlier downloaded plugins are available, the update plugins are downloaded to local plugin repository 350 (620). Whether or not update plugins are available, the flow proceeds to Step 630 where device driver core 340 determines whether one or more update plugins for device driver core 340 are available (630). If no update plugins for device driver core 340 are available, the update process is terminated (660). If one or more update plugins for device driver core 340 are available, the update plugins are downloaded to local plugin repository 350 (640) and configuration file 360 is updated to replace appropriate DLLs with update plugins (650) before the process is terminated (660).

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A method for automatically adapting an extensible imaging device driver, comprising the steps of:
querying a target imaging device;
identifying based on a query response received from the target imaging device a feature set;
identifying one or more features within the feature set that are locally supported using the device driver;
querying one or more remote server devices;
identifying based on one or more query responses received from the remote server devices one or more plugins that will enable the device driver to locally support additional features within the feature set;
downloading the plugins; and
locally storing the plugins.

2. The method of claim 1, wherein the feature set is a full feature set for the target imaging device.

3. The method of claim 1, wherein the feature set is a partial feature set for the target imaging device that addresses host emulation.

4. The method of claim 1, wherein the feature set is a partial feature set for the target imaging device that addresses a workflow integration.

5. The method of claim 1, wherein the device driver comprises a device driver core, and wherein the step of identifying one or more features within the feature set that are locally supported using the device driver comprises identifying one or more features that are natively supported by the device driver core and one or more features that are supported using plugins invoked by the device driver core.

6. The method of claim 1, wherein the remote server devices are queried via the Internet.

7. The method of claim 1, wherein the remote server devices are queried via a cellular network.

8. The method of claim 1, wherein the device driver comprises a device driver core, further comprising the steps of:
identifying based on one or more query responses received from the remote server devices one or more update plugins that will update the device driver core;
downloading the update plugins; and
storing the update plugins.

9. The method of claim 1, wherein the device driver comprises a device driver core, further comprising the steps of:
identifying based on one or more query responses received from the remote server devices one or more update plugins that will update plugins invoked by the device driver core;
downloading the update plugins; and
storing the update plugins.

10. The method of claim 1, further comprising the step of displaying information about the plugins to a user and obtaining authorization from the user to download the plugins.

11. The method of claim 10, wherein the displayed information includes licensing terms.

12. The method of claim 10, wherein the displayed information includes information indicating an extent to which the one or more plugins will enable the device driver to locally support features within the feature set.

13. The method of claim 1, wherein the stored plugins and the device driver are collocated on a client device.

14. The method of claim 1, wherein the plugins are operative for a predetermined term.

15. The method of claim 1, wherein the plugins are operative for a predetermined number of uses.

16. The method of claim 1, wherein the plugins comprise a user interface description.

17. A client device, comprising:
a processor; and
a communication interface communicatively coupled with the processor, wherein under control of the processor the client device queries a target imaging device via the communication interface, identifies based on a query response received from the target imaging device via the communication interface a feature set, identifies one or more features within the feature set that are locally supported, queries one or more remote server devices via the communication interface, identifies based on one or more query responses received from the remote server devices via the communication interface one or more plugins that will enable an extensible device driver on the client device to locally support additional features within the feature set and downloads and stores the plugins.

18. The device of claim 17, wherein the device driver comprises a device driver core and under control of the processor the client device identifies based on one or more query responses received from the remote server devices one or more update plugins that will update the device driver core and downloads and stores the update plugins.

19. The device of claim 17, wherein the device driver comprises a device driver core and under control of the processor the client device identifies based on one or more query responses received from the remote server devices one or more update plugins that will update one or more plugins invoked by the device driver core and downloads and stores the plugins.

20. The device of claim 17, further comprising a user interface, wherein under control of the processor the client device displays information about the plugins on the user interface, including licensing information, and obtains authorization from a user via the user interface to download the plugins.
